(19) United States
(12) Patent Application Publication
(10) Pub. No.: US 2024/0325251 A1
(43) Pub. Date: Oct. 3, 2024

(54) GELATIN MASS DELIVERY SYSTEM FOR SOFT GELATIN CAPSULE MANUFACTURING

(71) Applicants: Richard T. Chiang, San Marino, CA (US); Kevin J. Chiang, Irvine, CA (US)

(72) Inventors: Richard T. Chiang, San Marino, CA (US); Kevin J. Chiang, Irvine, CA (US)

(21) Appl. No.: 18/191,294

(22) Filed: Mar. 28, 2023

(51) Int. Cl. A61J 3/07; A23P 10/30; G05B 11/42; G05D 7/06

(52) U.S. Cl. CPC A61J 3/07; A23P 10/30; G05B 11/42; G05D 7/0635; A23L 29/284

(57) ABSTRACT

A gelatin mass delivery system for soft gelatin capsule manufacturing includes a gelatin tank holding a gelatin mass and a spreader box for forming a gelatin ribbon over a cooling drum. The tank has a plunger inside which applies pressure on top of the gelatin mass surface and pushes it out of the tank under pressurized air. With the tube insert and plunger, the tank outlet is at the bottom center, which reduces gelatin mass waste. The spreader box spread the gelatin mass via an opening slot over the cooling drum to form the gelatin ribbon, and uses a mechanism to adjust the height of the entire spreader box to precisely and reliably control the gelatin ribbon thickness. A gelatin mass flow control device is provided on the gelatin transfer tube between the tank and the spreader box, employing a pinching mechanism to control the gelatin mass flow rate.

### BACKGROUND OF THE INVENTION

This invention relates to apparatus and related method for manufacturing of soft gelatin capsules, and in particular, it relates to a gelatin mass delivery system for soft gelatin capsule manufacturing.

Soft gelatin capsules are also known as softgel capsules or softgels. Examples of soft gelatin capsules (softgels) are fish oil capsules and Nyquil™ capsules. Softgels are commonly used in the pharmaceutical, nutritional and cosmetic industries to encapsulate medicines, nutritional supplements and cosmetic products to deliver the content to be consumed internally or applied externally.

Softgel manufacturing starts with making a gelatin mass and a product material. In the subsequent processes, the gelatin mass will become the shell (or skin) and product material will become the content of the softgel capsules.

During manufacturing, a gelatin mass transfer system is used. Gelatin mass is a high viscosity liquid. In the manufacturing process, the gelatin mass is made in a melter or reactor and transferred to a temporary storage tank called gelatin tank, or holding tank, or receiver tank.

If gelatin (collagen) is used as a major ingredient, gelatin mass is then called animal based. It is commonly referred to as gelatin mass. The majority of the softgel capsules are made with animal based gelatin and are usually called softgel capsules or softgels. Carrageenan and various kinds of modified starch are free of animal derived products and are also used to make gelatin mass. This is called non-animal, animal-free or veggie (vegetable) gelatin mass. Softgel capsules made with non-animal, gelatin are often referred to as non-animal, animal free or veggie softgels.

### SUMMARY OF THE INVENTION

There are some common problems associated with softgel manufacturing, especially with non-animal based gelatin mass, due to its higher viscosity compared to animal base gelatin mass. One problem is that not all the gelatin mass can be used to make softgel capsules and is thus wasted. Another problem is that air bubbles in the gelatin ribbon create thin spots or holes on the shell of the softgel capsules, causing leaks, a waste of production resources.

Accordingly, the present invention is directed to equipment and related method of soft gelatin capsules manufacturing that substantially obviates one or more of the problems due to limitations and disadvantages of the related art.

An object of the present invention is to provide a gelatin mass delivery system that significantly reduces gelatin mass waste.

Another object of the present invention is to provide a gelatin mass delivery system that eliminates or substantially reduces air bubbles in the gelatin ribbon.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve the above objects, the present invention provides a gelatin mass delivery system for soft gelatin capsule manufacturing, which includes: a gelatin mass delivery system for soft gelatin capsule manufacturing, including: a gelatin tank assembly configured to contain a gelatin mass; a spreader box assembly; a gelatin transfer tube coupled to the gelatin tank assembly and the spreader box assembly, configured to transfer the gelatin mass from the gelatin tank assembly to the spreader box assembly; and a cooling drum; wherein the spreader box assembly has a chamber for containing the gelatin mass with an opening slot at the bottom of the chamber configured to spread the gelatin mass over the cooling drum to form a gelatin ribbon; wherein the gelatin tank assembly includes: a gelatin tank, having a pressured air inlet configured to introduce pressurized air into the gelatin tank, and a gelatin mass outlet located near a bottom center of the gelatin tank, the gelatin tank being otherwise air-tight; and a plunger disposed inside the gelatin tank, having a lower surface configured to contact the gelatin mass in the tank.

In another aspect, the present invention provides a gelatin mass delivery system for soft gelatin capsule manufacturing, which includes: a gelatin mass delivery system for soft gelatin capsule manufacturing, including: a gelatin tank assembly including a tank configured to contain a gelatin mass; a spreader box assembly; a gelatin transfer tube coupled to the gelatin tank assembly and the spreader box assembly, configured to transfer the gelatin mass from the gelatin tank assembly to the spreader box assembly; and a cooling drum; wherein the spreader box assembly is configured to spread the gelatin mass over the surface of the cooling drum to form a gelatin ribbon, the spreader box assembly including: a main body defining a chamber configured to contain the gelatin mass; an opening slot at the bottom of the main body and in fluid communication with the chamber, the opening slot being located at a distance above the surface of the cooling drum; one or more footings coupled to the main body, the footings resting on the cooling drum; each footing is coupled to the spreader boxes through a screw mechanism and configured to adjust height positions of the footings relative to the main body of the spreader box, thereby adjusting the distance between the opening slot and the surface of the cooling drum.

In another aspect, the present invention provides a gelatin mass delivery system for soft gelatin capsule manufacturing, which includes: a gelatin mass delivery system for soft gelatin capsule manufacturing, including: a gelatin tank assembly including a tank configured to contain a gelatin mass; a spreader box assembly; a gelatin transfer tube coupled to the gelatin tank assembly and the spreader box assembly, configured to transfer the gelatin mass from the gelatin tank assembly to the spreader box assembly; a gelatin mass flow control device coupled to the gelatin transfer tube, configured to control a flow rate of the gelatin mass in the gelatin transfer tube; and a cooling drum; wherein the spreader box assembly has a chamber for containing the gelatin mass and an opening slot at the bottom of the chamber configured to spread the gelatin mass over the cooling drum to form a gelatin ribbon; wherein the gelatin mass flow control device includes: an opening configured for the gelatin transfer tube to pass through; a moveable pinch bar located at one side of the opening, wherein movements of the pinch bar changes the width of the opening, thereby changing a cross-section of the gelatin transfer tube; and a screw coupled to the pinch bar and configured to move the pinch bar.

It is to be understood that both the foregoing general description and the following detailed description are exemplary and explanatory and are intended to provide further explanation of the invention as claimed.

### BRIEF DESCRIPTION OF DRAWINGS

FIG. 1 schematically illustrates a softgel capsule manufacturing system according to embodiments of the present invention.

FIG. 2 schematically illustrates a softgel capsule forming process.

FIGS. 3 (exterior view), 4 (exploded view) and 5 (partial cut-away and cross-sectional view) illustrate a gelatin tank assembly of the softgel capsule manufacturing system according to an embodiment of the present invention.

FIG. 6 illustrates a tube insert of the gelatin tank assembly of FIGS. 3-5.

FIG. 7 illustrates a tank plunger of the gelatin tank assembly of FIGS. 3-5.

FIG. 8 illustrates a gelatin flow control device (manual adjusting) of the softgel capsule manufacturing system according to an embodiment of the present invention.

FIG. 9 illustrates a gelatin flow control device (automatic control) of the softgel capsule manufacturing system according to another embodiment of the present invention.

FIG. 10 (cross-sectional view) illustrates a flow sensor of the gelatin flow control device (automatic control) of FIG. 9.

FIGS. 11 (exterior view) and 12 (partial cut-away and cross-sectional view) illustrate a spreader box assembly of the softgel capsule manufacturing system according to an embodiment of the present invention.

### DETAILED DESCRIPTION OF THE INVENTION

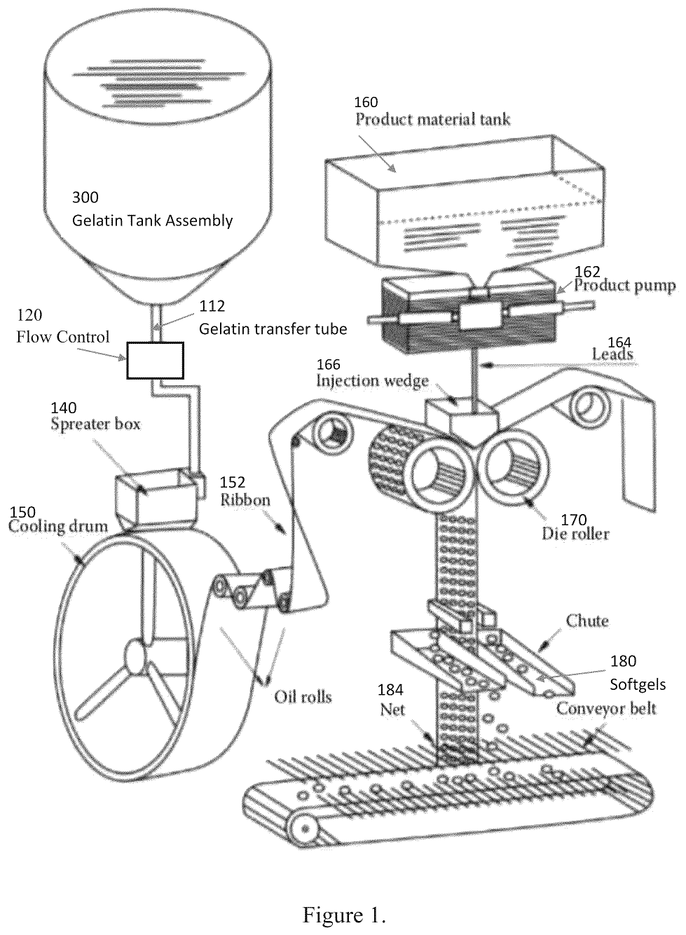

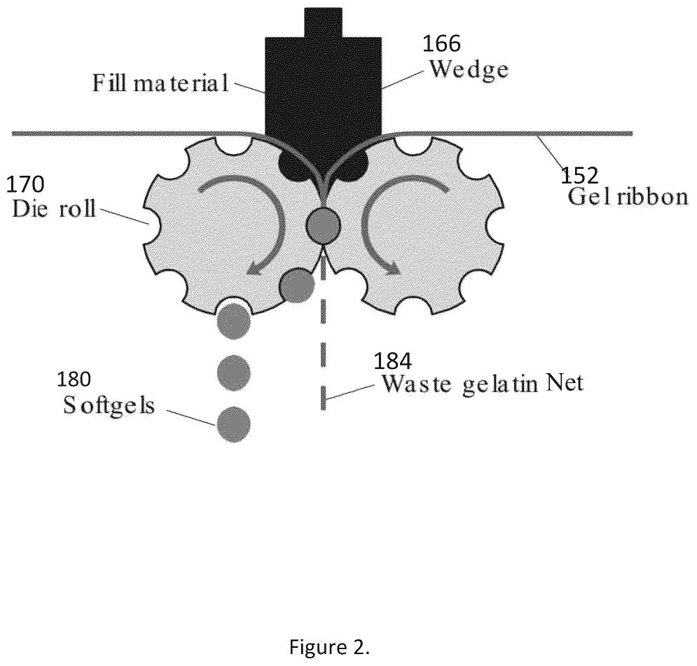

The present disclosure relates, in general, to equipment and implements for transferring a gelatin mass from a gelatin tank (or holding tank, receiver tank), through a flow control device, into a spreader box to form a gelatin ribbon over a cooling (or casting) drum for softgel capsule manufacturing (or encapsulation) process, as generally shown in FIGS. 1 and 2.

Gelatin mass manufacturing starts with mixing a gelatin powder, other solid ingredients (if any) and liquid ingredients in a jacket heated melter (or reactor) (not shown in the drawings). After the ingredients are melted, air bubbles will be vacuum removed. The resulting homogenous liquid mixture in the melter is referred to as the gelatin mass.

If none of the ingredients for gelatin mass is derived from animal, it is called a non-animal, animal-free, or veggie (vegetable) gelatin mass. Animal based gelatin mass can be either dropped out with gravity, or air pressured out of the melter (reactor) into a gelatin tank. Non-animal gelatin mass, due to its high viscosity, typically can only be air pressured out of the melter into the gelatin tank, at higher pressure than for animal based gelatin mass.

A gelatin mass delivery system according to embodiments of the present invention include the following main components (see FIG. 1): a gelatin tank (or holding tank, receiver tank) assembly 300, serving as temporary storage tank in manufacturing process; a gelatin mass flow control device 120, employing either manual or automatic flow control; and a spreader box assembly 140, which spreads the gelatin mass over a cooling drum to form a gelatin ribbon. More specifically:

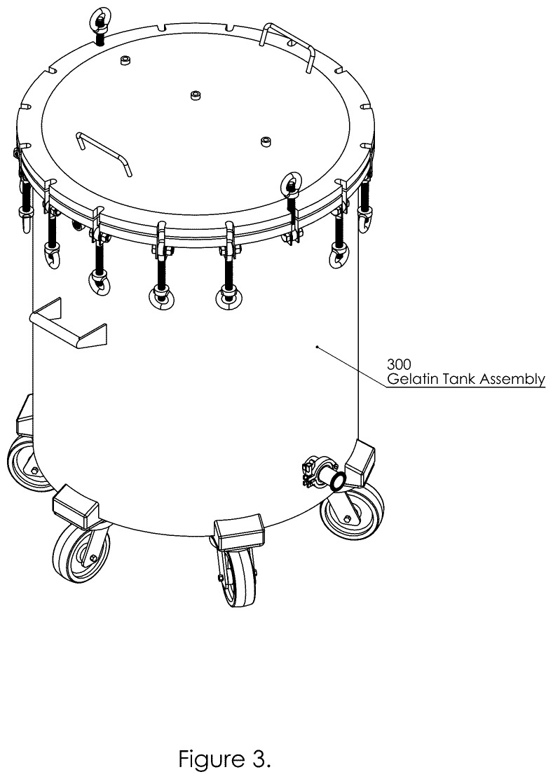

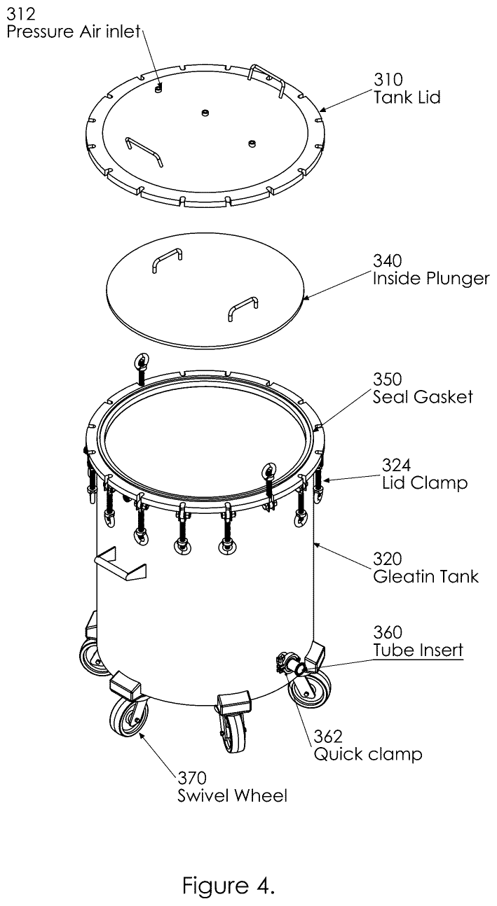

The gelatin tank according to embodiments of the present invention (see FIG. 3, 4) is designed to address the following problems: In conventional technologies, a common problem with non-animal gelatin mass is that some amount of gelatin mass in the gelatin tank cannot be air pressured out for production and is wasted. This is due to non-animal gelatin mass' higher viscosity compared to animal base gelatin. The gelatin tank according to embodiments of this invention, on the other hand, can push almost all the gelatin mass out of the gelatin tank, more than any other existing tanks. This significantly reduces gelatin waste commonly associated with non-animal gelatin mass. Moreover, the tank's structure is simple in design and easy to manufacture, easy to operate, easy to set up and clean, and saves labor and time in changing gelatin tanks in production.

The flow control system according to embodiments of the present invention is designed to control the flow of a high viscosity liquid, at a low flow rate, such as with the gelatin mass in the softgel manufacturing process. In conventional technologies a common method of controlling flow of high viscosity, slow moving liquid is to turn the flow ON/OFF, with devices such as butterfly valves or ball valves. The flow control according to embodiments of the present invention, on the other hand, uses a pinching mechanism to pinch a flexible transferring tube, thereby changing the inside cross section opening from 0% to 100% continuously, to achieve flow control.

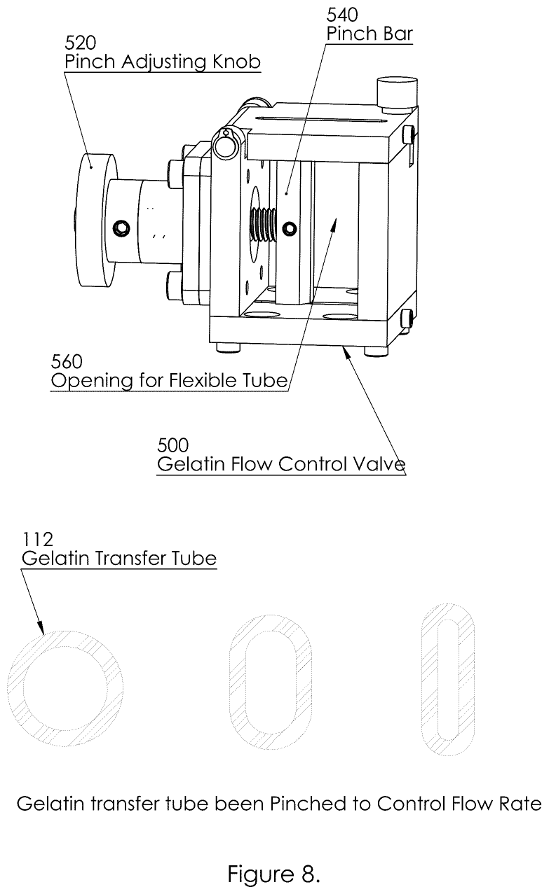

The flow control may use a manual control structure (see FIG. 8), where adjustment of flow rate is done manually by turning a knob coupled to a screw mechanism to move a pinching bar. The pinching bar pinches a flexible transferring tube to change its inside cross section opening from 0% to 100%.

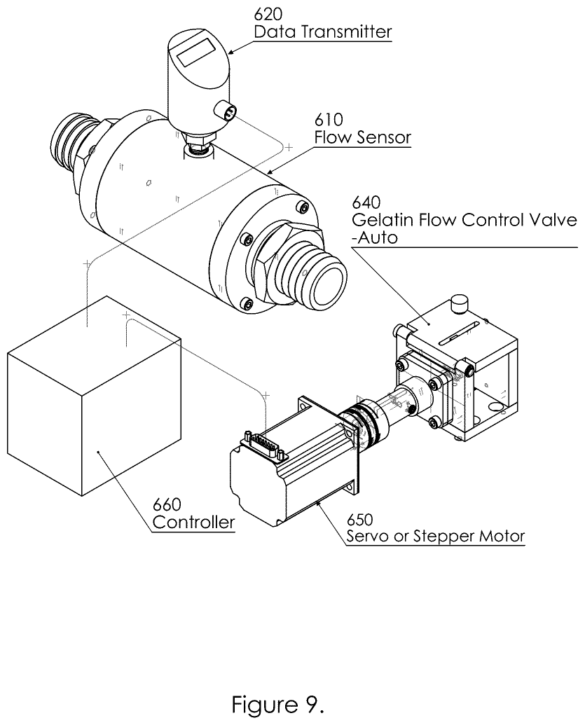

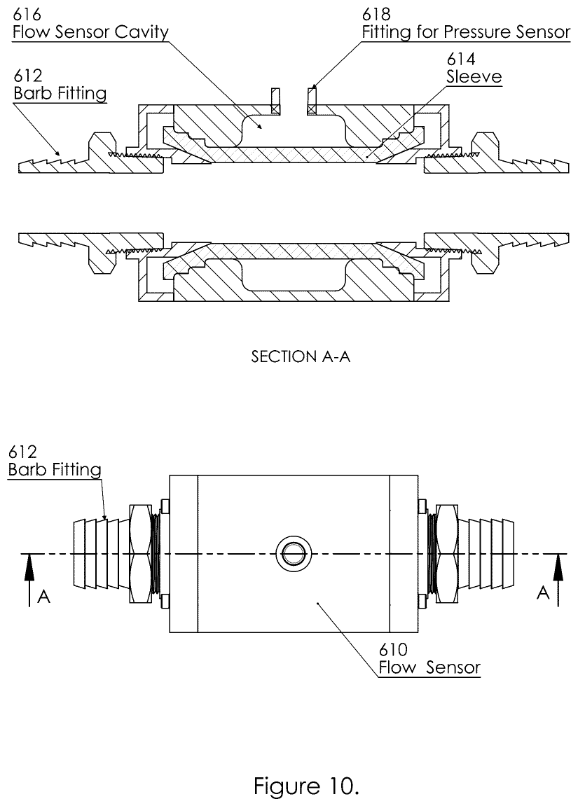

The flow control may alternatively use an automatic control structure (see FIG. 9), which employs the same pinch mechanism as in manual control, except that the pinching (the turning of the screw) is automatically controlled by control motor such as a servo motor or a stepper motor. As the gelatin mass is pressurized to flow through the flexible tube, the flow rate is proportional to the pressure; hence the flow rate may be determined by sensing the pressure inside the flexible tube (see FIG. 10). In this embodiment, to achieve automatic flow control, a flow sensor senses the gelatin pressure inside the flexible tube and a data transmitter sends the pressure value to a controller. The controller processes the value received and compare it to a reference value set by the operator in the controller. The controller then turns the control motor to adjust the pinching of the flexible tube to regulate the flow rate to the pre-set value. Thus the flow rate is automatically controlled by a closed loop system. The controller may use a PID (proportional-integral-derivative) control algorithm to regulate the flow rate.

By installing a pressure gauge, the flow sensor can be used as a flow rate indicator.

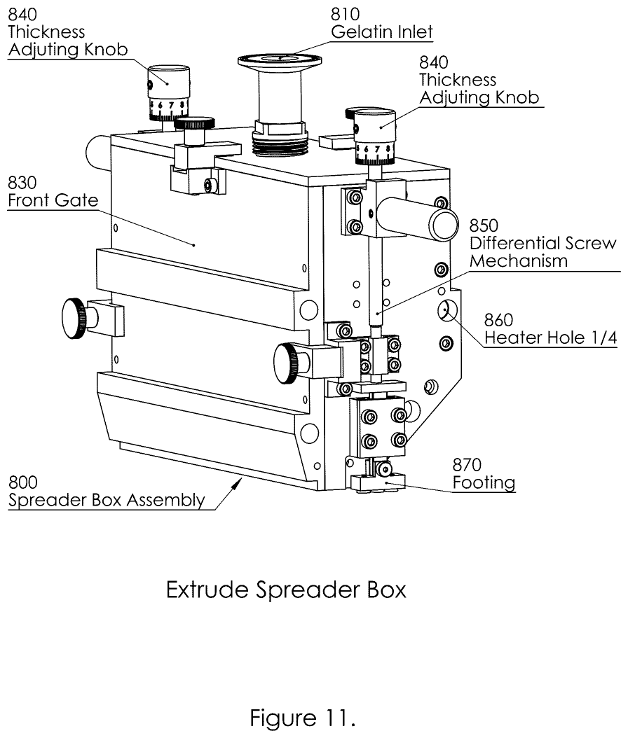

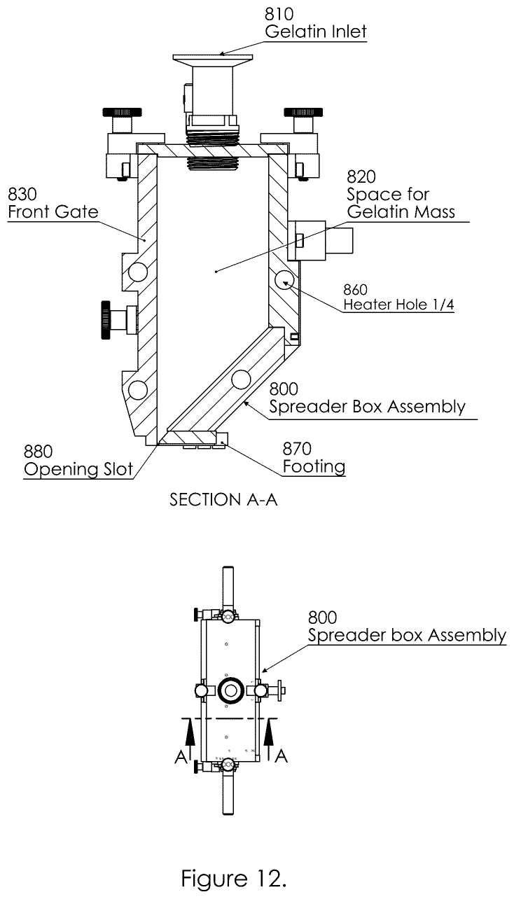

The spreader box according to embodiments of the present invention (see FIGS. 11 and 12) is designed to address two common problems with conventional technology. One common problem of conventional technologies with non-animal gelatin mass is air bubbles in the ribbon. In the spreader box according to embodiments of the present invention, the gelatin mass is fed from the top of the spreader box. The pressure applied to the gelatin in the gelatin tank pushes the gelatin mass into the spreader box and extruded it out of the spreader box through the opening slot at the bottom to form a ribbon on the cooling drum. The opening slot is the only exit for the gelatin mass in the spreader box. Since the gelatin mass is extruded out of the spreader box, there are no air bubbles in the ribbon.

Another common problem with the spreader box in conventional technologies is the difficulties in thickness adjustment and its stability. Almost all existing spreader boxes use a screw mechanism to move only the front gate of the spreader box to adjust the gap between the bottom of the gate and the cooling drum to control the ribbon thickness. Due to the backlash between male and female screws, adjustment is hard to predict, or control. Multiple passes of adjustments are needed to get the right thickness. Also, the ribbon thickness does not stay stable due to the settlement of screw backlash. Usually, ribbon thickness needs to be checked and adjusted every 20 to 30 minutes or less.

The spreader box according to embodiments of the present invention moves the entire spreader box main body up and down to adjust the gap between the bottom of the spreader box and the cooling drum to adjust the ribbon thickness. By using the weight of the spreader box, backlash in the screw mechanism is eliminated and the ribbon thickness stays stable throughout the production period. By eliminating backlash, thickness adjustment is very predictable and it is much quicker to get the right thickness.

In conventional technologies, almost all existing spreader boxes use a screw to move only the front gate up and down for ribbon thickness adjustment. For very fine thickness adjustment, such as 0.001″, 0.01 mm, with the resolution of one screw, usually it takes several passes of adjustments to get the right ribbon thickness. More often than not, thickness adjustment of 0.001″ or 0.01 mm cannot be accomplished.

In the spreader box according to some embodiments of the present invention, on the other hand, a differential screw mechanism is employed to increase the resolution multiple times. As a result, the ribbon thickness can be adjusted to the right value with far fewer passes. In most cases, only one adjustment is needed to reach the right value, even adjusting very fine values such as 0.001″, 0.01 mm, or less.

The various components of the softgel capsule manufacturing system according to embodiments of the present invention are described in more detail below.

As illustrated in FIG. 1, the gelatin tank assembly 300 is used to store and supply a gelatin mass 330 flow through the gelatin transfer tube 112. The flow rate of the gelatin is regulated by the flow control device 120 and the gelatin mass flows into the spreader box assembly 140 (label 800 in FIGS. 11 and 12). The bottom opening slot 880 of spreader box assembly 140 (800) spreads the gelatin mass over the surface of the cooling drum 150 to form a gelatin ribbon 152. The cooling drums rotate continuously while in operation. While the gel mass is being extruded out of the spreader box through the bottom narrow opening slot 880 and the drum is turning, a flat, continuous ribbon 152 is formed on the drum surface. The drum surface is chilled by a chiller (not shown) through circulating liquid, such as water or water and glycol mixture, such that the surface is just cold enough to chill the gel mass from high viscosity flowing liquid into an elastic and flexible ribbon, but not cold enough to make the gel ribbon hard. Two sets of the above structures, left and right, are provided to form two ribbons 152, although FIG. 1 only shows one set of the structures.

FIG. 2 shows how the softgel capsules 180 are formed. The product material to be contained in the softgels is stored in a product material tank 160 and fed through a product pump 162 and leads 164 into an injection wedge 166. Two gelatin ribbons 152 are fed between two die rollers 170 and the injection wedge 166. The two gelatin ribbons 152 meet between the two die rollers 170 and the wedge 166 where the two gelatin ribbons 152 are cut while the wedge 166 injects the product material between the two gelatin ribbons 152. The cutting actions forms a capsules and seals the product material inside, thus forming the softgel capsules 180. The product material is injected into the capsule while the capsules are been formed by two die rolls. A waste gelatin net 184 is discharged below the die rollers 170.

FIG. 3 is an exterior view, FIG. 4 is an exploded view, and FIG. 5 is a partial cut-away and cross-sectional view, of the gelatin tank assembly 300, showing its major components.

As mentioned earlier, for a non-animal gelatin mass 330, due to its high viscosity, the gelatin mass needs to be pushed out of the gelatin tank with air pressure. Many existing conventional gelatin tank designs cannot push all non-animal gelatin mass out of the tank, resulting in waste of material. Many existing gelatin tank designs are complicated, hard to clean and hard to operate (for example, changing gelatin tanks in production may need two or more persons). The gelatin tank according to embodiments of this invention described here addresses the problems mentioned above: this gelatin tank has almost no waste, and is easy to operate, clean and build. The system according to embodiments of this invention can be used for both animal and non-animal gelatin mass 330.

In FIG. 5, the gelatin tank assembly 300 is shown in its set up in operation. A plunger 340 is sitting on top of the gelatin mass 330 inside the tank 320. The tank is cylindrical and the plunger has a shape (viewed from the top) that fits the interior shape of the tank 320, and is able to move up and down on the top surface of the gelatin mass. Lid clamps 324 keep the gelatin tank lid 310 in place and a seal gasket 350 keeps the inside of the tank airtight. Through the pressure air inlet 312, pressurized air fills the top empty space of the inside of the tank, applying pressure onto the plunger 340. In turn, the plunger 340 applies a pressure and pushes gelatin mass 330 out of the gelatin tank through the gelatin mass outlet 364 of the tube insert 360 and out through the tank outlet 366. The gelatin mass outlet 364 is the only inside outlet of the gelatin tank. In other words, the gelatin tank is airtight except for the air inlet 312 and the gelatin mass outlet 364.

Waste of gelatin mass happens in conventional gelatin tanks where there is no plunger. Without a plunger, the pressurized air acts directly on the gelatin mass. As the gelatin mass is pushed out of the holding tank, the level of the gelatin mass gets lower. When the gelatin mass is not thick enough to block the pressurized air from going out of the tank's outlet, the pressurized air will tunnel (or go, push) through the gelatin mass and out of the gelatin holding tank. When this happens, the gelatin mass remaining in the holding tank can no longer be used for production and is thus wasted. This can happen when the gelatin mass is as thick as up to 5 inches. This problem happens almost all the time with non-animal gelatin in gelatin tanks in use, since higher pressure is needed for higher viscosity non-animal gelatin mass as compared to animal base gelatin mass.

In embodiments of the present invention, as shown in FIG. 5, the gelatin mass outlet 364 is at the bottom center of the tank. The pressurized air has no direct contact with the gelatin mass 330 except along the rim of the plunger 340. Thus tunneling of pressurized air is prevented. In other words, pressurized air is not able go out of the gelatin tank 320, until almost all gelatin mass 330 is out of the tank. This tank enables almost all, more than any other tank design, of the gelatin mass 330 to be pushed out of the tank 320, with almost no waste. As an option plastic sheet can be placed between top of the gelatin mass and bottom of the plunger, to keep the plunger from touching the gelatin mass, but still can applying pressure to the gelatin mass.

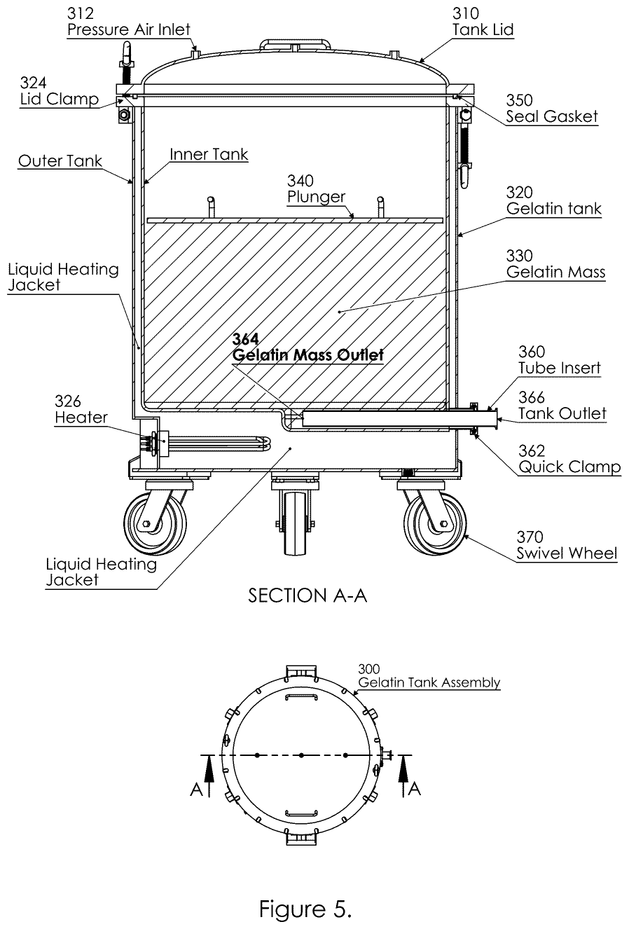

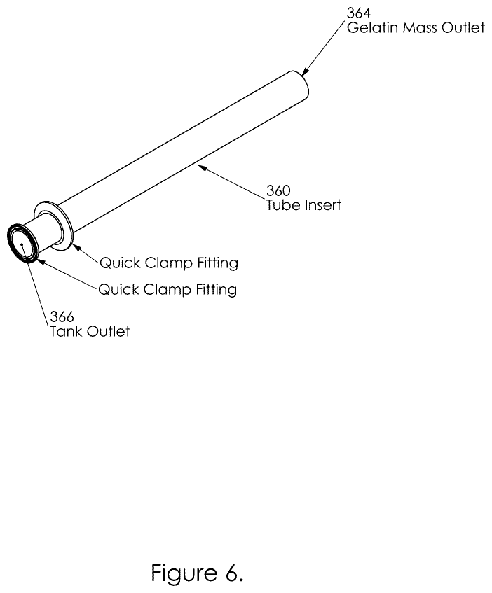

FIG. 6 shows the tube insert 360, which is part of the gelatin tank assembly 300. The tube inert 360 is configured to connect to the gelatin mass outlet 364 of the tank 320 and serve as the outlet 366 of the gelatin tank assembly 300 for connection to the gelatin transfer tube 112. Quick clamp fittings 362 are provided on the tube insert 360 and the exterior of the tank to retain the tube insert 360. With tube insert 360, the outlet of the gelatin tank is at the inside bottom center of the tank.

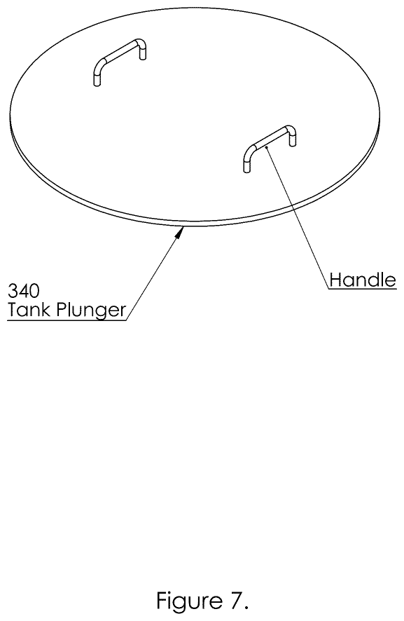

FIG. 7 shows the plunger 340, which is part of the gelatin tank assembly 300. As shown in FIG. 7, the plunger has a substantially flat bottom surface configured to contacts the gelatin mass 330, which is suitable for a gelatin tank 320 that has a flat bottom (see FIG. 5). In alternative embodiments, the gelatin tank bottom may be another shape (in a side cross-sectional view), such as an arced or other curved shape, a cone or truncated cone shape, etc., and the bottom surface of the plunger 340 has a shape that generally matches the shape of the bottom of the gelatin tank 320. Also as shown in FIG. 7, the plunger is provided with one or more handles for easy handling.

The gelatin tank assembly 300 shown in FIG. 5 also has a heater 326 located in a lower part of the assembly, and a set of swivel wheels 370 to facilitate its movement.

Referring back to FIG. 1, the gelatin mass 330 from the tank assembly 300 is transferred by a gelatin transfer tube 112 to the spreader box assembly 140. A flow control device 120 on the transfer tube 112 regulates the flow to a steady adjustable rate. The function of the spreader box assembly 140 is to form the gelatin ribbon 152. In order to make the thickness of the ribbon 152 consistent throughout the production cycle, the gelatin flow control device 120 is employed to keep the flow rate steady.

In the illustrated embodiments, the flow control device 120 controls the flow rate of gelatin mass 330 by pinching the flexible transfer tube 112, either manually with a gelatin flow manual control valve 500, or automatically with a gelatin flow automatic control valve 640.

FIG. 8 shows the gelatin flow manual control valve 500. By turning a pinch adjusting knob 520, through a screw mechanism, a pinch bar 540 coupled to the knob can be moved to pinch the flexible transfer tube 112 which is going through an opening 560 of the flow control device, thereby changing its cross section area, e.g., from 0% (close) to 100% (fully open). The flow rate can thus be controlled continuously.

FIG. 9 shows how the gelatin mass 330 flow rate is automatically control with the automatic control valve 640, which uses the same pinching mechanism as in the manual control device 500 except that the pinch adjusting knob 520 is replaced with a control motor 650, such as servo motor or stepper motor, controlled by a controller 660. The flow rate is set by the operator at the controller. The actual flow rate in the transfer tube 112 is measured by a flow sensor 610 and send by a data transmitter 620 to the controller 660. The controller 660 adjusts the gelatin flow automatic control valve 640 by turning the control motor 650, to change the cross section of the flexible transfer tube 112. By changing the cross section area through pinching, the flow rate can be adjusted to a pre-set value. PID (proportional-integral-derivative) control algorithm is employed by the controller to keep the flow rate steady.

FIG. 10 shows the details of the flow sensor 610, which is connected in-line on the transfer tube 112 via barb fittings 612. The sensor includes a flexible sleeve 614 which is exposed to the interior of the flow passage. As pressure from the gelatin tank 300 pushes the gelatin mass 330 through the flow passage, the gelatin mass exerts a pressure on the wall of the flexible sleeve 614. A space behind (around) the flexible sleeve 614, i.e. the flow sensor cavity 616, is filled with a liquid such as mineral oil, glycerin, etc. Pressure of the liquid is sensed by a pressure sensor installed on a fitting 618 and in fluid communication with the flow sensor cavity 616 (the pressure sensor may be located in the same housing as the data transmitter 620 shown in FIG. 9). The sensed pressure data, which is representative of the gelatin mass flow rate, is sent to the controller 660 by the data transmitter 620.

A pressure gauge can also be installed on the flow sensor 610 as a flow rate indicator. Without automatic control, operator can manually adjust the flow control valve 500 based on the reading of the pressure gauge.

FIGS. 11 (exterior view) and 12 (partial cut-away and cross-sectional view) show details of the spreader box assembly 800. The footings 870 of the assembly are the only parts touching the cooling drum 150. In a preferred embodiment, the footings 870 rest directly on the moving surface of the cooling drum 150 and glide along it as the drum rotates. The drums surface is preferably made of stainless steel with polished or grinded surfaces, and the footings preferably have Teflon pads sitting on the drum surface. Some footings may be made of brass only as an integrated part of the spreader box. In alternative embodiments, the footings 870 may rest on a non-moving part of the cooling drum 150 that has a defined spatial relationship with the drum surface, such as a frame of the cooling drum that provides a pair of testing points respectively located adjacent to the two side edges of the drum surface. The gelatin mass 330 is fed into the spreader box assembly 800 (labeled 140 in FIG. 1), under pressure, through a gelatin inlet 810 on top and fills the chamber (interior space for gelatin) 820 of the box. The non-animal gelatin mass 330 is pushed out of the spreader box assembly 800 through the bottom opening slot 880 to form a ribbon over the surface of the cooling drum 150. In other words, the gelatin mass 330 is pressured and extruded out of the spreader box assembly 800 through the bottom opening slot 880 to form a ribbon 152 over the cooling drum 150 as shown in FIG. 1.

The thickness of the ribbon is adjusted by adjusting the height of the main body of the spreader box assembly 800 (and hence the bottom opening slot 880) relative to the surface of the cooling drum 150. This is done by turning the ribbon thickness adjusting knobs 840 that are coupled to the footings. Through a differential screw mechanism 850 coupled to each knob 840, the relative position of the respective footing 870 (which touches the cooling drum 150) with respect to the main body of the spreader box assembly 800 is adjusted. As a result, the main body is moved up and down relative to the cooling drum 150, thereby adjusting the gap between the opening slot 880 at the bottom of spreader box assembly 800 and the surface of the cooling drum 150, which in turn adjusts the thickness of the ribbon 152.

The differential screw mechanism 850 is designed to give finer thickness adjustment than single screw adjusting mechanisms. With the differential screw, the scale on the ribbon thickness adjusting knob 840 can be as fine as 0.001″, 0.0005″, or 0.01 mm per scale as marked on the thickness adjusting knob 840.

In conventional technologies, the spreader box moves its front gate only with single screw mechanisms to adjust the thickness of the ribbon. As the resolution of the single screw is much coarser than that of the differential screw, the adjustment is not as accurate. Moreover, the backlash of the screw on conventional spreader boxes makes the adjustment hard to predict. As a result, several adjustment passes are needed to reach the right thickness, if it can be reached at all. The backlash also makes the thickness unstable and it tends to change over time.

In the spreader box assembly 800 according to embodiments of the present invention, because the entire main body of the spreader box is moved to adjust the ribbon thickness, there is no backlash with the differential screw mechanism. So the thickness is very stable. Thickness adjustment is predictable and accurate. Most of the time, only one adjustment is needed, verses multiple passes with current spreader box design.

In the illustrated embodiment, the opening slot 880 is linearly shaped and extends in a direction parallel to the rotational axis of the cooling drum; two footings 870 are located on two ends of the spreader box assembly near the two opposite ends of the opening slot 880, and two thickness adjusting knobs 840 are provided correspondingly. Both footings are adjusted to keep the opening slot parallel to the surface of the cooling drum 150 and at the desired height. In alternative embodiments, other numbers of footings may be provided and/or the footings may be located at other locations. For example, in an alternative embodiment, two footings may be provided on two sides of the opening slot 880 (i.e., in the sectional view of FIG. 12, to the left and right of the opening slot). In another alternative embodiment, the spreader box assembly may be pivotally installed, with the pivoting axis parallel to the opening slot (i.e. parallel to the rotation axis of the cooling drum 150, in a direction perpendicular to the drawing sheet in the sectional view of FIG. 12), and one footing may be provided to cause the spreader box assembly 800 to pivot slightly in order to change the vertical distance between the opening slot 880 and the surface of the cooling drum 150. Further, the footings are not required to be located at the bottom of the spreader box assembly 800; for example, it is possible to mount the main body of the spreader box assembly 800 on a support frame which has adjustable footings, with the footings of the support frame resting on the cooling drum 150.

As shown in FIGS. 11 and 12, the spreader box assembly 800 also includes a front gate 830 that provides access to interior of the spreader box, and heater holes 860 passing through walls of the box to allow heating of the content.

It will be apparent to those skilled in the art that various modification and variations can be made in the gelatin mass delivery system and related method of the present invention without departing from the spirit or scope of the invention. Thus, it is intended that the present invention cover modifications and variations that come within the scope of the appended claims and their equivalents.

1. A gelatin mass delivery system for soft gelatin capsule manufacturing, comprising:
a gelatin tank assembly configured to contain a gelatin mass;
a spreader box assembly;
a gelatin transfer tube coupled to the gelatin tank assembly and the spreader box assembly, configured to transfer the gelatin mass from the gelatin tank assembly to the spreader box assembly; and
a cooling drum;
wherein the spreader box assembly has a chamber for containing the gelatin mass with an opening slot near a bottom of the chamber configured to spread the gelatin mass over the cooling drum to form a gelatin ribbon;
wherein the gelatin tank assembly includes:
a gelatin tank, having a pressured air inlet configured to introduce pressurized air into the gelatin tank, and a gelatin mass outlet located near a bottom of the gelatin tank, the gelatin tank being otherwise air-tight; and
a plunger disposed inside the gelatin tank, having a lower surface configured to contact the gelatin mass in the tank.

2. The gelatin mass delivery system of claim 1, wherein the plunger has a shape in a top view that fits an interior shape of the gelatin tank.

3. The gelatin mass delivery system of claim 1, wherein the lower surface of the plunger has a shape in a side cross-sectional view that matches a shape of the bottom of the gelatin tank.

4. The gelatin mass delivery system of claim 1, wherein the gelatin mass outlet is located near a bottom center of the gelatin tank.

5. The gelatin mass delivery system of claim 1, wherein the gelatin tank assembly further includes a tube insert, wherein one end of the tube insert is couple to the gelatin mass output of the gelatin tank, and another end of the tube insert is coupled to the gelatin mass transfer tube.

6. The gelatin mass delivery system of claim 1, further comprising a gelatin mass flow control device coupled to the gelatin transfer tube, configured to control a flow rate of the gelatin mass in the gelatin transfer tube.

7. A gelatin mass delivery system for soft gelatin capsule manufacturing, comprising:
a gelatin tank assembly including a tank configured to contain a gelatin mass;
a spreader box assembly;
a gelatin transfer tube coupled to the gelatin tank assembly and the spreader box assembly, configured to transfer the gelatin mass from the gelatin tank assembly to the spreader box assembly; and
a cooling drum;
wherein the spreader box assembly is configured to spread the gelatin mass over a surface of the cooling drum to form a gelatin ribbon, the spreader box assembly including:
a main body defining a chamber configured to contain the gelatin mass;
an opening slot near a bottom of the main body and in fluid communication with the chamber, the opening slot being located at a distance above the surface of the cooling drum;
at least two footings coupled to the main body, the footings resting on the cooling drum; and
one screw coupled to each footings and configured to adjust height positions of the footings relative to the main body, thereby adjusting the distance between the opening slot and the surface of the cooling drum.

8. The gelatin mass delivery system of claim 7, wherein the spreader box assembly further includes one adjusting knob for each footing coupled to the corresponding screw for turning the screw.

9. The gelatin mass delivery system of claim 7, wherein the one or more screws are differential screws.

10. The gelatin mass delivery system of claim 7, wherein the opening slot is linearly shaped and oriented in a direction parallel to a rotation axis of the cooling drum, and wherein the one or more footings include two footings located near two ends of the opening slot.

11. The gelatin mass delivery system of claim 7, wherein the spreader box assembly further includes a gelatin inlet located near a top of the chamber.

12. The gelatin mass delivery system of claim 7, further comprising a gelatin mass flow control device coupled to the gelatin transfer tube, configured to control a flow rate of the gelatin mass in the gelatin transfer tube.

13. A gelatin mass delivery system for soft gelatin capsule manufacturing, comprising:
a gelatin tank assembly including a tank configured to contain a gelatin mass;
a spreader box assembly;
a gelatin transfer tube coupled to the gelatin tank assembly and the spreader box assembly, configured to transfer the gelatin mass from the gelatin tank assembly to the spreader box assembly;
a gelatin mass flow control device coupled to the gelatin transfer tube, configured to control a flow rate of the gelatin mass in the gelatin transfer tube; and
a cooling drum;
wherein the spreader box assembly has a chamber for containing the gelatin mass and an opening slot near a bottom of the chamber configured to spread the gelatin mass over the cooling drum to form a gelatin ribbon;
wherein the gelatin mass flow control device includes:
an opening configured for the gelatin transfer tube to pass through;
a moveable pinch bar located at one side of the opening, wherein movements of the pinch bar changes a width of the opening, thereby changing a cross-section of the gelatin transfer tube; and
a screw coupled to the pinch bar and configured to move the pinch bar.

14. The gelatin mass delivery system of claim 13, wherein the gelatin mass flow control device further includes a manually operable knob coupled to the screw to turn the screw, thereby moving the pinch bar and adjusting the flow rate of the gelatin mass in the gelatin transfer tube.

15. The gelatin mass delivery system of claim 13, wherein the gelatin mass flow control device further includes a control motor coupled to the screw to turn the screw, thereby moving the pinch bar and adjusting the flow rate of the gelatin mass in the gelatin transfer tube.

16. The gelatin mass delivery system of claim 15, wherein the gelatin mass flow control device further includes:
a controller electrically coupled to the control motor; and
a flow sensor coupled in-line on the gelatin transfer tube, configured to measure the flow rate of the gelatin mass in the gelatin transfer tube and to transmit a flow rate measurement result to the controller;
wherein the controller is configured to control the control motor based on the flow rate measurement result.

17. The gelatin mass delivery system of claim 16, wherein the flow sensor includes:
a flexible sleeve defining a passage for the gelatin mass;
a cavity formed around of the flexible sleeve;
a liquid filling the cavity; and
a pressure sensor in fluid communication with the cavity, configured to sense a pressure in the liquid, the pressure being representative of the gelatin mass flow rate.

18. The gelatin mass delivery system of claim 16, wherein the controller controls the control motor using a PID (proportional-integral-derivative) algorithm to regulate the flow rate to a preset value.
